(19) United States
(12) Patent Application Publication
(10) Pub. No.: US 2020/0173311 A1
(43) Pub. Date: Jun. 4, 2020

(54) A SYSTEM AND METHOD FOR RECOVERING ENERGY

(71) Applicant: Bowman Power Group Limited, Southampton Hampshire (GB)

(72) Inventor: Paul Dowman-Tucker, Southampton (GB)

(73) Assignees: Bowman Power Group Limited, Southampton (GB); Bowman Power Group Limited, Southampton (GB)

(21) Appl. No.: 16/311,077

(22) PCT Filed: May 31, 2017
(86) PCT No.: PCT/GB2017/051553

§ 371 Date: Dec. 18, 2018

(30) Foreign Application Priority Data
Jun. 30, 2016 (GB) 1611479.5

(51) Int. Cl. F01K 23/10; F01K 25/08; F02G 5/04; F01N 5/02; F01N 5/04

(52) U.S. Cl. CPC F01K 23/10; F01K 25/08; F01N 5/04; F01N 5/02; F02G 5/04

(57) ABSTRACT

A system for recovering exhaust energy from fluid in an exhaust conduit of a reciprocating engine is described. There is an organic rankine cycle having a heat exchanger arranged to evaporate a working fluid of the organic rankine cycle passing through a low temperature side of the heat exchanger, in which the exhaust conduit is arranged in fluid communication with an inlet of a high temperature side of the heat exchanger for heat exchange of the fluid in the exhaust conduit downstream of the reciprocating engine to the working fluid of the organic rankine cycle. Also a turbine is arranged to receive the working fluid evaporation expansion and then a generator driven by the turbine is arranged to convert shaft power into electric power. A further organic rankine cycle having a heat exchanger arranged to evaporate a working fluid of the further organic rankine cycle passing through a low temperature side of the heat exchanger, in which an engine cooling water conduit is arranged in fluid communication with an inlet of a high temperature side of the heat exchanger for heat exchange of the fluid in the cooling water conduit downstream of the reciprocating engine to the working fluid of the further organic rankine cycle is included and further comprising a further turbine arranged to receive the working fluid evaporation expansion of the further organic rankine cycle, whereby the generator is additionally driven by the further turbine of the further organic rankine cycle to convert shaft power into electric power. The single generator is driven by two independent turbine expanders. A method for operation of the apparatus is also described.

This application is a national stage entry under 35 U.S.C. § 371 of International Application No. PCT/GB2017/051553, filed May 31, 2017, which claims the benefit of GB Application No. 1611479.5, filed Jun. 30, 2016. The entire contents of International Application No. PCT/GB2017/051553 and GB Application No. 1611479.5 are incorporated herein by reference.

### TECHNICAL FIELD

The disclosure relates to a system and method for recovering energy recovering from fluid in an exhaust conduit and cooling circuit of a reciprocating engine. The exhaust gas from the exhaust conduit and cooling fluid in the cooling circuit are utilised as inputs into the heat exchangers of two Organic Rankine Cycles (ORC).

### BACKGROUND

An ORC is a well known form of energy production that is both clean, efficient and a reliable form of producing electricity. It is known in the art to use the exhaust flow of a reciprocating engine as a source of heat that can indirectly provide an input into the evaporator of an ORC, this waste heat recovery is an area of growing importance for ORC circuits. Similarly it is known in the art to use engine cooling fluids as a source of heat energy.

The working fluids used for an ORC are usually refrigerants or hydrocarbons. The fluids have a low temperature boiling point and a decomposition temperature of around 160-170° C. It is imperative that the working fluid of the ORC does not decompose into its constituent elements as these include corrosive acids which can be both damaging and dangerous. For this reason, the temperature of the exhaust gas emanating from the engine must be reduced sufficiently that it passes through the evaporator at a temperature that will evaporate the refrigerant without it decomposing. There are commercially available prior art systems such as that shown in FIG. 1.

The system is shown schematically in FIG. 1. Exhaust flow from the engine 1 passes through the engine turbocharger 10 and then through the high temperature side of a heat exchanger 30 in the coil circuit 20 before flowing to an exhaust outlet 35. The working fluid of the intermediate circuit is oil, which is pumped through the low temperature side of the heat exchanger 30 where it is heated by the exhaust gas before being passed through the high temperature side of a further heat exchanger 40 forms part of the Organic Rankine Cycle. The oil temperature is low enough as it passes through the heat exchanger 40 that it evaporates the working fluid of the Organic Rankine Cycle without decomposition taking place. The working fluid is then expanded through turbine 50 and is finally recondensed at condenser 60 before it is pumped back through the heat exchanger/evaporator 40. This type of system has been used in industry to date.

An intermediate oil circuit can be used in order to stop the working fluid of the ORC overheating.

Another prior art scheme is described in GB 2501458. However, so far ORC solutions struggle to gain popularity and mainstream success due to the high commercial costs.

There are very few applications where the equipment payback period is viable (i.e. where it is less than 3 yrs).

It is an aim of the present disclosure to redress at least to some extent the problems of the prior art.

### SUMMARY

In accordance with the present invention, as seen from a first aspect, there is provided a system for recovering exhaust energy from fluid in an exhaust conduit of a reciprocating engine, the system comprising, an organic rankine cycle having a heat exchanger arranged to evaporate a working fluid of the organic rankine cycle passing through a low temperature side of the heat exchanger, in which the exhaust conduit is arranged in fluid communication with an inlet of a high temperature side of the heat exchanger for heat exchange of the fluid in the exhaust conduit downstream of the reciprocating engine to the working fluid of the organic rankine cycle, a turbine arranged to receive the working fluid evaporation expansion wherein a generator driven by the turbine is arranged to convert shaft power into electric power, a further organic rankine cycle having a heat exchanger arranged to evaporate a working fluid of the further organic rankine cycle passing through a low temperature side of the heat exchanger, in which an engine cooling water conduit is arranged in fluid communication with an inlet of a high temperature side of the heat exchanger for heat exchange of the fluid in the cooling water conduit downstream of the reciprocating engine to the working fluid of the further organic rankine cycle, and comprising a further turbine arranged to receive the working fluid evaporation expansion of the further organic rankine cycle, whereby the generator is additionally driven by the further turbine of the further organic rankine cycle to convert shaft power into electric power. Here the single generator is driven by two independent turbine expanders leading to economies of equipment and efficient operation. The system simultaneously recovers heat both the engine jacket cooling water and the exhaust gas. This invention offers an opportunity to reduce costs by enabling a key component of the system, the expander, to be driven by two working fluid circuits, thus increasing the energy that may be recovered, but without doubling the cost of the overall system.

By the disclosure and the coupling of two turbine expanders to a single high-speed electric machine, with each expander being part of an independent working fluid circuit arranged as an Organic Rankine Cycle efficiencies can be achieved. The design of each ORC circuit is such that the design speed of the turbine expanders is the same so that they may be simultaneously connected to a single electric machine for the conversion of mechanical work into high-frequency electrical energy. The target application for this technology is waste heat recovery for reciprocating engines which, necessity provide both a low grade and medium/high grade waste heat source in the jacket cooling water and the main exhaust respectively, although other areas of application can be envisaged.

In a preferred embodiment the system further comprises power electronics, arranged to convert the electrical energy from the generator into preferably low voltage three phase power. This system with two independent turbine expanders only requires one set of these power electronics not two due to the turbine expanders combining together to driving a single generator.

The preferred embodiment described above include two organic rankine cycles, but more cycles and circuits are possible. In this instance multiple tandem/twin turbogenerators could be used, or alternatively a single generator could be coupled with 2 or more turbines directly coupled to a single shaft. This multiple approach would be for processes beyond and alternate to a reciprocating internal combustion engine where there are more than 2 heat sources.

In a further preferred embodiment the maximum temperature of the working fluid in the two or more organic rankine cycles upon evaporation is less than 250 degrees Celsius. This is the desired temperature range, although the system envisages operating outside this range.

Preferably, the generator comprises an alternator arranged to convert shaft power into electric power to extract heat from fluid in the turbine exhaust conduit and heat from the fluid in the cooling water conduit. As required, and as in the preferred illustrated embodiment the system further comprises a turbocharger arranged in fluid communication with the engine exhaust conduit, the turbocharger comprising a compressor and a second further turbine, wherein the second further turbine is arranged in fluid communication with the engine exhaust conduit to extract heat from fluid in the engine exhaust conduit, and wherein the turbine is arranged downstream of the second further turbine and in an exhaust conduit of the further turbine to extract heat from fluid in the second further turbine exhaust conduit. The turbocharger is a preferred feature of the internal combustion engine.

Preferably the engine cooling water jacket is a closed circuit. This is particularly preferable for land based applications. In the alternative and for ship-based applications in a marine environment then the cooling water conduit comprises part of an open circuit, from and to the sea. Preferably, there are one or more sets of fluid pump and condenser in the system.

It is preferable for efficiencies that with the two independent turbine expanders then the one or more heat exchanger circuits are arranged to utilise and share heat exchanger hardware. In other preferable arrangements the system is arranged to recover exhaust energy from fluid in a non-reciprocating engine or other hardware. This means the simultaneous recovery of heat both from the cooling water and the exhaust gas can be used with systems and implemented on hardware other than the internal combustion engine.

In accordance with the present disclosure, as seen from a second aspect, there is provided a method of operating a system for recovering exhaust energy from fluid in an exhaust conduit of a reciprocating engine using the system apparatus as set out above. The method of operation provides a reduction in the initial costs and the lifetime costs of ORC applications for reciprocating engines.

### BRIEF DESCRIPTION OF THE DRAWINGS

FIG. 1 is a schematic of a prior art system for recovering engine exhaust energy using an Organic Rankine Cycle.

FIG. 2 is a schematic view of a system apparatus in accordance with an embodiment of the present disclosure as seen from a first aspect.

FIG. 3 is a flow diagram of a method of operation of the system as shown in FIG. 2, and in accordance with a further aspect of the present disclosure.

### DETAILED DESCRIPTION

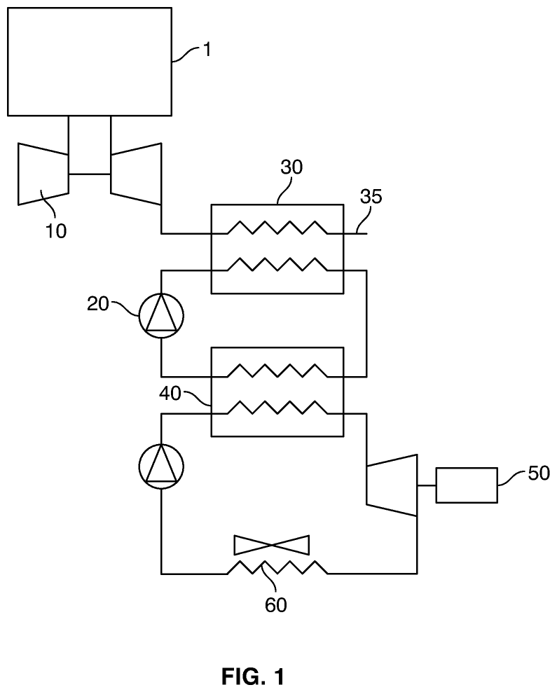

With reference to FIG. 1 of the drawings a prior art system is shown with an ORC circuit where exhaust flow from the engine 1 passes through the engine turbocharger 10 and then through the high temperature side of a heat exchanger 30 in the circuit 20 before flowing to an exhaust outlet 35.

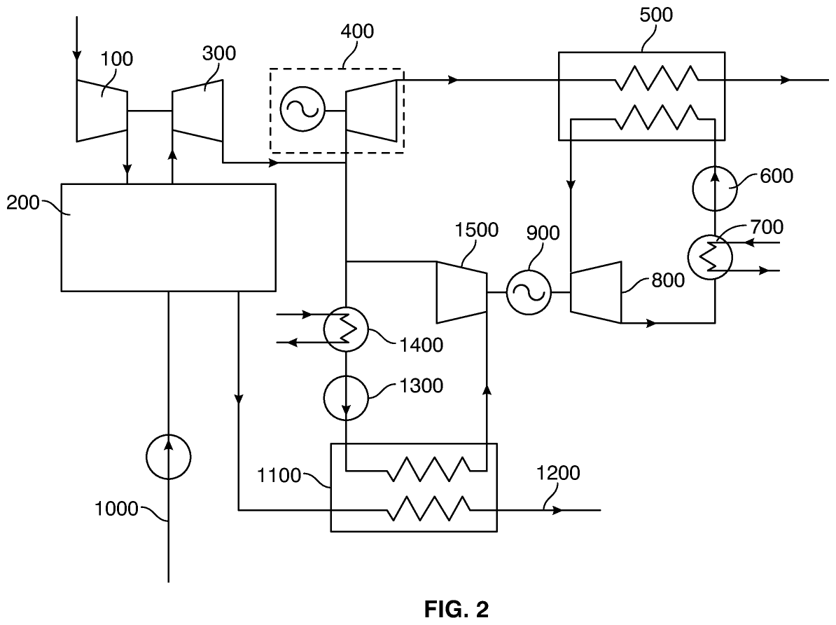

In FIG. 2, a conventional, turbocharged, reciprocating engine is shown with the waste heat recovery system of the present disclosure, combustion air is drawn into a compressor (100) and pressurised to deliver ‘charge’ or ‘boost’ air to the engine (200). Following combustion this is discharged via a turbine (300) which is coupled to, and provides motive power to the compressor (100). In this disclosure the exhaust air, which may be characterised as medium/high grade heat, having a temperature of between 350 and 600 degrees Celsius is then passed through a heat exchanger (500), with the option of an intervening second expansion in further turbine connected to a high-speed generator (400), before being discharged to atmosphere. The other side of the heat exchanger (500) is a closed circuit of a suitable working fluid. The working fluid is pumped around this circuit (600) and, following evaporation in the heat exchanger (500) it is expanded across a turbine (800) that is directly coupled to a high-speed generator (900) that converts the mechanical work into electrical energy. Following expansion the working fluid is cooled in a condenser before passing to the pump (600) to repeat the cycle.

In addition, the engine has a jacket cooling water circuit which takes cool (c. 20-30 degrees Celsius) water in and then discharges the water as a low-grade heat source with a temperature of around 80-90 degrees Celsius. Before returning to the water to a cooling medium, in this disclosure the water is passed through a heat exchanger (1100), before discharge (1200). The other side of the heat exchanger is a closed circuit of a suitable working fluid, which may be a common fluid with the circuit already described above. The working fluid is pumped around this circuit (1300) and, following evaporation in the heat exchanger (500) it is expanded across a turbine (1500) that is directly coupled to a high-speed generator (900) that converts the mechanical work into electrical energy. Following expansion the working fluid is cooled in a condenser before passing to the pump (1300) to repeat the cycle.

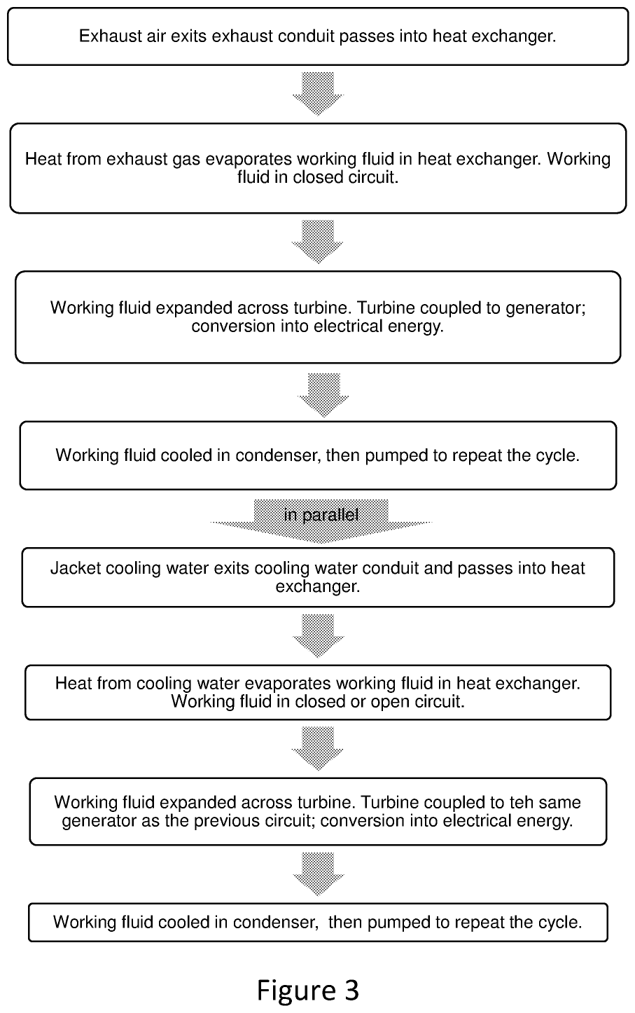

In operation, as set out in the diagram at FIG. 3, also with reference to FIG. 2, the operation of the ORC system, of the disclosure are set out.

Various modifications may be made to the described embodiment without departing from the scope of the present disclosure. The structure and arrangement of the system apparatus may be of an alternative design. The system may recover exhaust energy from other engines other than a reciprocating internal combustion engine. The system components may comprise any suitable material or construction.

1. A system for recovering exhaust energy from fluid in an exhaust conduit of a reciprocating engine, the system comprising;
a first organic rankine cycle having a first heat exchanger arranged to evaporate a working fluid of the first organic rankine cycle passing through a low temperature side of the first heat exchanger, in which the exhaust conduit is arranged in fluid communication with an inlet of a high temperature side of the first heat exchanger for heat exchange of the fluid in the exhaust conduit downstream of the reciprocating engine to the working fluid of the first organic rankine cycle,
a first turbine arranged to receive the working fluid evaporation expansion, wherein a generator driven by the first turbine is arranged to convert shaft power into electric power,
a second organic rankine cycle having a second heat exchanger arranged to evaporate a working fluid of the second organic rankine cycle passing through a low temperature side of the second heat exchanger, in which an engine cooling water conduit is arranged in fluid communication with an inlet of a high temperature side of the second heat exchanger for heat exchange of the fluid in the cooling water conduit downstream of the reciprocating engine to the working fluid of the second organic rankine cycle, and
a second turbine arranged to receive the working fluid evaporation expansion of the second organic rankine cycle, whereby the generator is additionally driven by the second turbine of the second organic rankine cycle to convert shaft power into electric power.

2. A system as claimed in claim 1, further comprising power electronics, arranged to convert the electrical energy from the generator into low voltage three phase power.

3. A system as claimed in claim 1, comprising three or more organic rankine cycles.

4. A system as claimed in claim 1, in which the maximum temperature of the working fluid in the first and second organic rankine cycles upon evaporation is less than 250 degrees Celsius.

5. A system as claimed in claim 1, wherein the generator comprises an alternator arranged to convert shaft power into electric power to extract heat from fluid in the turbine exhaust conduit and heat from the fluid in the cooling water conduit.

6. A system as claimed in claim 1, further comprising a turbocharger arranged in fluid communication with the engine exhaust conduit, the turbocharger comprising a compressor and a third turbine, wherein the third turbine is arranged in fluid communication with the engine exhaust conduit to extract heat from fluid in the engine exhaust conduit, and wherein the first turbine is arranged downstream of the third turbine and in an exhaust conduit of the second turbine to extract heat from fluid in the exhaust conduit of the third turbine.

7. A system as claimed in claim 1, wherein the cooling water conduit comprises part of a closed circuit, preferably a water jacket circuit.

8. A system as claimed in claim 1, wherein the cooling water conduit comprises part of an open circuit, preferably in a marine application from and to the sea.

9. A system as claimed in claim 1, further comprising one or more sets of fluid pump and condenser.

10. A system as claimed in claim 1, wherein the heat exchangers are arranged to utilise and share heat exchanger hardware.

11. A system as claimed in claim 1, arranged to recover exhaust energy from fluid in a non-reciprocating engine or other hardware.

12. A method of operating a system for recovering exhaust energy from fluid in an exhaust conduit of a reciprocating engine, the method comprising:
evaporating, with a first organic rankine cycle having a first heat exchanger, a working fluid of the first organic rankine cycle passing through a low temperature side of the first heat exchanger, in which the exhaust conduit is arranged in fluid communication with an inlet of a high temperature side of the first heat exchanger for heat exchange of the fluid in the exhaust conduit downstream of the reciprocating engine to the working fluid of the first organic rankine cycle,
receiving, with a first turbine, the working fluid evaporation expansion, wherein a generator driven by the first turbine is arranged to convert shaft power into electric power,
evaporating, with a second organic rankine cycle having a second heat exchanger, a working fluid of the second organic rankine cycle passing through a low temperature side of the second heat exchanger, in which an engine cooling water conduit is arranged in fluid communication with an inlet of a high temperature side of the second heat exchanger for heat exchange of the fluid in the cooling water conduit downstream of the reciprocating engine to the working fluid of the second organic rankine cycle, and
receiving, with a second turbine, the working fluid evaporation expansion of the second organic rankine cycle, whereby the generator is additionally driven by a second turbine of the second organic rankine cycle to convert shaft power into electric power.

13. A system for recovering exhaust energy from fluid in an exhaust conduit of a non-reciprocating engine, the system comprising;
a first organic rankine cycle having a first heat exchanger arranged to evaporate a working fluid of the first organic rankine cycle passing through a low temperature side of the first heat exchanger, in which the exhaust conduit is arranged in fluid communication with an inlet of a high temperature side of the first heat exchanger for heat exchange of the fluid in the exhaust conduit downstream of the reciprocating engine to the working fluid of the first organic rankine cycle,
a first turbine arranged to receive the working fluid evaporation expansion wherein a generator driven by the first turbine is arranged to convert shaft power into electric power,
a second organic rankine cycle having a second heat exchanger arranged to evaporate a working fluid of the second organic rankine cycle passing through a low temperature side of the second heat exchanger, in which an engine cooling water conduit is arranged in fluid communication with an inlet of a high temperature side of the second heat exchanger for heat exchange of the fluid in the cooling water conduit downstream of the reciprocating engine to the working fluid of the second organic rankine cycle, and
a second turbine arranged to receive the working fluid evaporation expansion of the second organic rankine cycle, whereby the generator is additionally driven by the second turbine of the second organic rankine cycle to convert shaft power into electric power.
